(19) United States
(12) Patent Application Publication
(10) Pub. No.: US 2026/0131662 A1
(43) Pub. Date: May 14, 2026

(54) A BRAKE SYSTEM

(71) Applicant: PROTEAN ELECTRIC LIMITED, FARNHAM, SURREY (GB)

(72) Inventor: Richard FORD, Farnham, Surrey (GB)

(21) Appl. No.: 18/705,263

(22) PCT Filed: Oct. 20, 2022
(86) PCT No.: PCT/GB2022/052679

§ 371 Date: Apr. 26, 2024

(30) Foreign Application Priority Data
Oct. 28, 2021 (GB) 2115500.7

(51) Int. Cl. B60L 7/26; B60L 7/18

(52) U.S. Cl. CPC B60L 7/26; B60L 7/18; B60L 2240/461; B60L 2240/465

(57) ABSTRACT

The brake system includes a controller arranged in response to receiving a torque demand to generate a first control signal for applying a regenerative braking torque by a first electric motor to a first wheel, wherein the first control signal provides an indication of a regenerative braking torque value, and a second control signal for applying a friction braking torque by a friction braking device to the first wheel, wherein the second control signal provides an indication of a friction braking torque value, wherein upon determining an estimate for the friction braking torque applied to the first wheel the controller is arranged to modulate the regenerative braking torque applied by the first electric motor to the first wheel based on the difference between the friction braking torque value indicated by the second control signal and the estimated friction braking torque.

### RELATED APPLICATION

This application is based on prior filed copending International Application No. PCT/GB2022/052679 filed Oct. 20, 2022, which claims priority to Great Britain Application No. 2115500.7, filed Oct. 28, 2021, the entire subject matter of these applications is incorporated herein by reference in its entirety.

### TECHNICAL FIELD

The present invention relates to a brake system, in particular a brake system for a vehicle having a wheel driven by an electric motor.

### BACKGROUND

Typically an electric motor drive system used to provide drive for a vehicle will also be used to provide regenerative braking. However, due to the braking requirements for a vehicle, the electric motor drive system will not be able to provide all the required braking torque. Consequently, braking systems for an electric vehicle typically incorporate a combination of friction braking and regenerative braking.

However, for brake systems that perform torque actuation centrally, these systems can suffer performance limitations due to the lag between the central actuation of the brake torque and the application of the generated brake torque to the vehicle.

In the context of an electric vehicle motor, a drive design that is becoming increasing popular is an integrated in-wheel electric motor design in which an electric motor is integrated within a wheel of a vehicle, where the use of an in wheel motors allows the torque actuation functionality to be moved outwards to the wheel itself.

An in wheel electric motor also provides the advantage of offering a fast speed control loop that runs on an in wheel motor controller, where the fast speed control loop controls torque actuation generated by the in wheel electric motors to allow rapid torque modulation.

However, integrating a fast speed control loop that runs on an in wheel electric motor and a friction braking system to ensure that an optimum level of braking torque is applied at all times can be problematic.

It is desirable to improve this situation.

### SUMMARY

In accordance with an aspect of the present invention there is provided a braking system according to the accompanying claims.

The present invention provides the advantage of allowing a braking system to provide different levels of brake blending between friction braking and regenerative braking depending on an operation mode of a vehicle, for example whether anti-lock braking has been activated.

### BRIEF DESCRIPTION OF THE DRAWINGS

The present invention will now be described, by way of example, with reference to the accompanying drawings, in which:

FIG. 1 illustrates a vehicle incorporating a traction control system according to an embodiment of the present invention;

FIG. 2 illustrates an exploded view of a motor embodying the present invention;

FIG. 3 illustrates a schematic representation of a control device;

FIG. 4 illustrates a brake system controller according to an embodiment of the present invention.

### DETAILED DESCRIPTION

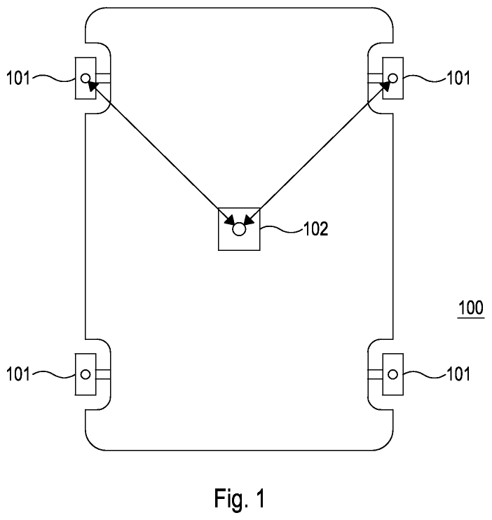

FIG. 1 illustrates a vehicle 100, for example a car or lorry, having four wheels 101, where two wheels are located in the vehicles forward position in a near side and off side position respectively. Similarly, two additional wheels are located in the vehicles aft position in near side and off side positions respectively, as is typical for a conventional car configuration. However, as would be appreciated by a person skilled in the art, the vehicle may have any number of wheels.

Each wheel includes a friction brake for applying a friction brake torque to the respective wheel.

Incorporated within the wheels 101 in the vehicle's aft position are in-wheel electric motors, as described in detail below. Although the current embodiment describes a vehicle having in-wheel electric motors associated with the wheels 101 located in the vehicle's aft position, as would be appreciated by a person skilled in the art the in-wheel electric motors can be located in other wheels. For example, in-wheel electric motors can be located in the front two wheels. Additionally, although the present embodiment describes the use of in-wheel electric motors, other electric motor configurations can be used, for example two in-board mounted electric motor, where each electric motor uses a drive shaft to drive a respective wheel.

Coupled to the in-wheel electric motors and to a vehicle communication bus, for example a CAN bus (not shown), is a control unit 102 that in conjunction with control devices mounted on each of the respective in wheel electric motors is arranged to control the drive and brake torque (i.e. regenerative brake torque) generated by the in-wheel electric motors, as described below.

As also described below, the control unit 102 is arranged to generate a wheel brake torque demand that is used to generate a friction brake torque applied by the friction brakes and a regenerative brake torque applied by the in-wheel electric motors. The torque request will typically be initiated by either a user of the vehicle 100 indicating a desire to increase or decrease the acceleration of the vehicle, for example with the use of a throttle pedal and/or a brake pedal, or via a vehicle control unit, which may be incorporated within the control unit 102, that automatically controls the speed/acceleration of the vehicle, such as an autonomous vehicle controller that provides a level of autonomous driving.

For the purpose of illustration the in-wheel electric motor is of the type having a set of coils being part of the stator for attachment to the vehicle, radially surrounded by a rotor carrying a set of magnets for attachment to a wheel. However, as would be appreciated by a person skilled in the art, the present invention is applicable to other types of electric motors. Typically, upon demand, an in-wheel electric motor will be configured to provide both drive torque and regenerative braking torque.

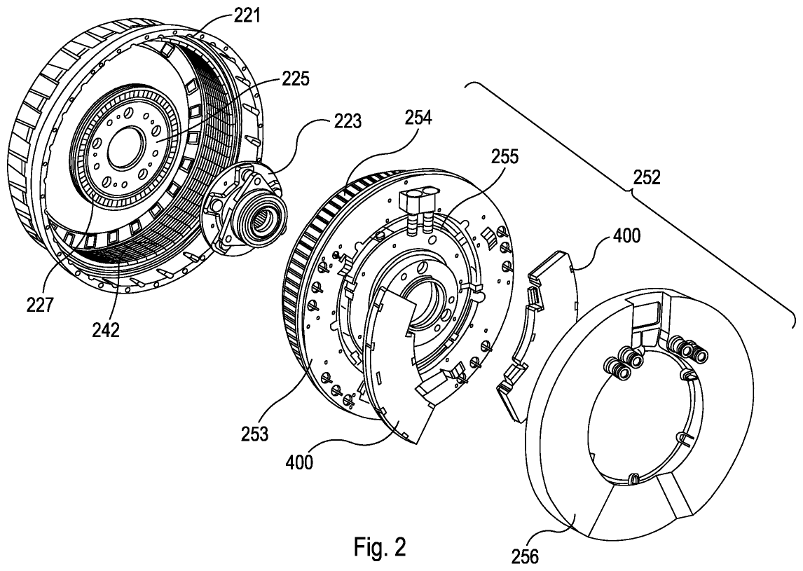

For the purposes of the present embodiment, as illustrated in FIG. 2, the in-wheel electric motor includes a stator 252 comprising a circumferential support 253 that acts as a heat sink, multiple coils 254, two control devices (not shown) mounted on the circumferential support 253 on a rear portion of the stator for driving the coils, and an annular capacitor (not shown), otherwise known as a DC link capacitor, and a lead frame (not shown), described below, that is mounted between an axial edge of the coils and an axial flange formed on the circumferential support for coupling the control devices to the coils. The coils 254 are formed on stator tooth laminations to form coil windings. A stator cover 256 is mounted on the rear portion of the stator 252, enclosing the control devices and annular capacitor to form the stator 252, which may then be fixed to a vehicle and does not rotate relative to the vehicle during use.

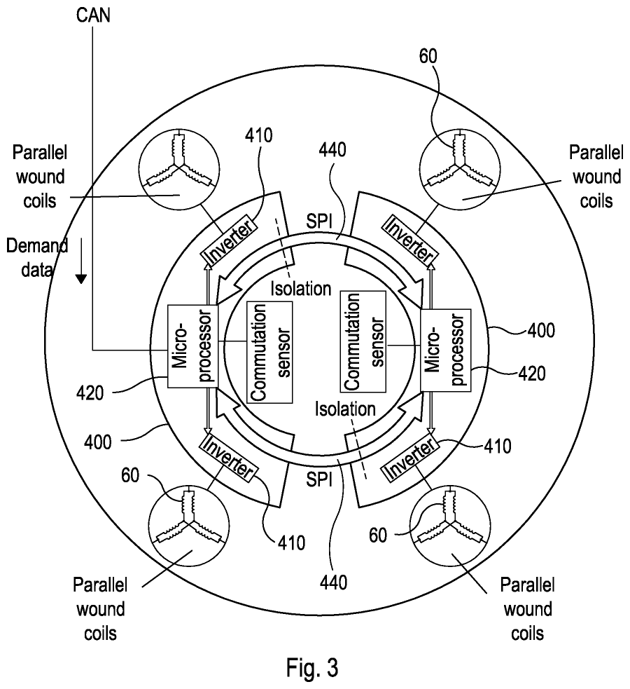

As schematically represented in FIG. 3, each control device 400 includes an inverter 410 with one of the control devices including control logic 420, which in the present embodiment includes a processor, for controlling the operation of both inverters 410. Each inverter is coupled to three sets of coil windings, arranged electrically in parallel, to form a set of three sub motors, as described below.

The annular capacitor is coupled between the inverters 410 and the electric motor's DC power source for reducing voltage ripple on the electric motor's power supply line, otherwise known as the DC busbar, and for reducing voltage overshoots during operation of the electric motor. For reduced inductance the capacitor is preferably mounted adjacent to the control devices 400.

A rotor 240 comprises a front portion 220 and a cylindrical portion 221 forming a cover, which substantially surrounds the stator 252. The rotor includes a plurality of permanent magnets 242 arranged around the inside of the cylindrical portion 221. For the purposes of the present embodiment 32 magnet pairs are mounted on the inside of the cylindrical portion 221. However, any number of magnet pairs may be used.

The magnets are in close proximity to the coil windings on the stator 252 so that magnetic fields generated by the coils interact with the magnets 242 arranged around the inside of the cylindrical portion 221 of the rotor 240 to cause the rotor 240 to rotate. As the permanent magnets 242 are utilized to generate a drive torque for driving the electric motor, the permanent magnets are typically called drive magnets.

The rotor 240 is attached to the stator 252 by a bearing block (not shown). The bearing block can be a standard bearing block as would be used in a vehicle to which this motor assembly is to be fitted. The bearing block comprises two parts, a first part fixed to the stator and a second part fixed to the rotor. The bearing block is fixed to a central portion of the wall of the stator 252 and also to a central portion of the housing wall 220 of the rotor 240. The rotor 240 is thus rotationally fixed to the vehicle with which it is to be used via the bearing block at the central portion of the rotor 240. This has an advantage in that a wheel rim and tyre can then be fixed to the rotor 240 at the central portion using the normal wheel bolts to fix the wheel rim to the central portion of the rotor and consequently firmly onto the rotatable side of the bearing block. The wheel bolts may be fitted through the central portion of the rotor through into the bearing block itself. With both the rotor 240 and the wheel being mounted to the bearing block there is a one to one correspondence between the angle of rotation of the rotor and the wheel.

The rotor also includes a set of magnets (not shown) for position sensing, otherwise known as commutation magnets, which in conjunction with sensors mounted on the stator allows for a rotor flux angle to be estimated, which is used by the control devices to control current flow within the coils using space vector pulse width modulation, as described below. The rotor flux angle defines the positional relationship of the drive magnets to the coil windings. Alternatively, in place of a set of separate magnets the rotor may include a ring of magnetic material that has multiple poles that act as a set of separate magnets.

To allow the commutation magnets to be used to calculate a rotor flux angle, preferably each drive magnet has an associated commutation magnet, where the rotor flux angle is derived from the flux angle associated with the set of commutation magnets by calibrating the measured commutation magnet flux angle. To simplify the correlation between the commutation magnet flux angle and the rotor flux angle, preferably the set of commutation magnets has the same number of magnets or magnet pole pairs as the set of drive magnet pairs, where the commutation magnets and associated drive magnets are approximately radially aligned with each other. Accordingly, for the purposes of the present embodiment the set of commutation magnets has 32 magnet pairs, where each magnet pair is approximately radially aligned with a respective drive magnet pair.

A sensor, which in this embodiment is a Hall sensor, is mounted on the stator. The sensor is positioned so that as the rotor rotates each of the commutation magnets that form the commutation magnet ring respectively rotates past the sensor.

As the rotor rotates relative to the stator the commutation magnets correspondingly rotate past the sensor with the Hall sensor outputting an AC voltage signal, where the sensor outputs a complete voltage cycle of 360 electrical degrees for each magnet pair that passes the sensor, where the AC voltage signal output by the Hall sensor can be used for both rotor position detection and for determining rotor velocity (ω).

For improved position detection, preferably the sensor includes an associated second sensor placed 90 electrical degrees displaced from the first sensor.

In the present embodiment the electric motor includes six coil sets with each coil set having three coil sub-sets that are coupled in a wye configuration to form a three phase sub-motor, resulting in the motor having six three phase sub-motors, where as stated above the respective coils of the six coil sets are wound on individual stator teeth, which form part of the stator. The operation of the respective sub-motors is controlled via one of two control devices 300, as described below. Although the present embodiment describes an electric motor having six coil sets (i.e. six sub motors) the motor may equally have one or more coil sets with an associated control device. Equally, each coil set may have any number of coil sub-sets, thereby allowing each sub-motor to have two or more phases.

FIG. 3 illustrates the connections between the respective coil sets 60 and the control devices 400, where three coil sets 60 are connected to a respective three phase inverter 410 included on a control device 400. As is well known to a person skilled in the art, a three phase inverter contains six switches, where a three phase alternating voltage may be generated by the controlled operation of the six switches.

The six switches are configured as three parallel sets of two switches, where each pair of switches is placed in series and form a leg of the three phase bridge circuit.

However, the number of switches will depend upon the number of voltage phases to be applied to the respective sub motors, where the sub motors can be constructed to have any number of phases. Each control device 400 is arranged to communicate with the other control device 400 via a communication bus 440.

Preferably, the control devices 400 are of a modular construction. In a preferred embodiment each control device, otherwise known as a power module, includes a power printed circuit board on which is mounted a control printed circuit board, two power source busbars for connecting to a DC battery via the DC link capacitor, three phase winding busbars for connecting to respective coil windings via the lead frame, and a power substrate assembly, which includes an inverter.

The power printed circuit board includes a variety of other components that include drivers for the inverter switches formed on the power substrate assembly, where the drivers are used to convert control signals from the control printed circuit board into a suitable form for operating switches mounted on the power printed circuit board, however these components will not be discussed in any further detail.

One of the control devices 400 includes a processor 420 for controlling the operation of the inverter switches in both control devices 400. Additionally, each control device 400 includes an interface arrangement to allow communication between the respective control devices 400 via a communication bus 440 with one control device 400 being arranged to communicate with the control unit 102 mounted external to the electric motor.

The processor 420 in the respective control device 400 is arranged to control the operation of the inverter switches mounted within each control device 400 to allow each of the electric motor coil sets 60 to be supplied with a three phase voltage supply, thereby allowing the respective coil sub-sets to generate a rotating magnetic field. As stated above, although the present embodiment describes each coil set 60 as having three coil sub-sets, the present invention is not limited by this and it would be appreciated that each coil set 60 may have one or more coil sub-sets.

Under the control of the processor, each three phase bridge inverter 410 is arranged to provide PWM voltage control across the respective coil sub-sets, thereby generating a current flow in the respective coil sub-sets for providing a required torque by the respective sub-motors.

PWM control works by using the motor inductance to average out an applied pulse voltage to drive the required current into the motor coils. Using PWM control an applied voltage is switched across the motor windings. During the period when voltage is switched across the motor coils, the current rises in the motor coils at a rate dictated by their inductance and the applied voltage. The PWM voltage control is switched off before the current has increased beyond a required value, thereby allowing precise control of the current to be achieved.

For a given coil set 60 the three phase bridge inverter 310 switches are arranged to apply a single voltage phase across each of the coil sub-sets.

Using PWM switching, the plurality of switches are arranged to apply an alternating voltage across the respective coil sub-sets. The voltage envelope and phase angle of the electrical signals is determined by the modulating voltage pulses.

The inverter switches can include semiconductor devices such as MOSFETs or IGBTs. In the present example, the switches comprise IGBTs. However, any suitable known switching circuit can be employed for controlling the current.

The inverter 410 formed on the power assembly in one control device 400 is coupled to three coil sets, to form a first set of three sub motors, with the inverter 410 formed on the power assembly in the other control device 400 being coupled to the other coil sets, to form a second set of three sub motors.

Both inverters 410 are coupled to the respective coil sets via the lead frame, where each leg of the respective inverters is coupled to the lead frame via a respective phase winding busbar. For the purposes of the present embodiment, the different voltage phases generated by each inverter leg are designated W, V and U.

The coil windings are coupled to the lead frame, as described below, to allow current to flow from the DC power source via the respective inverters in the control devices to the coil windings to allow drive torque to be generated by the electric motor.

As discussed above, the processor is arranged to receive a torque demand from the control unit 102 via the CAN interface, however any form of communication link between the control unit 102 and the respective motor drive controller 80 can be used.

As each in-wheel electric motor is directly coupled to a wheel, this allows for the torque generated by the respective in wheel electric motors to be instantly applied to a wheel, where the generated torque at any given time is accurately known by the control circuitry within the control devices attached to the in-wheel electric motors. Accordingly, the in wheel electric motors provide the advantage of having both an extremely quick torque response and speed sensing loop.

As stated above, the torque request will typically be initiated by either a user of the vehicle 100 indicating a desire to increase or decrease the acceleration of the vehicle, for example with the use of a throttle pedal and/or a brake pedal, or via a vehicle control unit, which may be incorporated within the control unit 102, that automatically controls the speed/acceleration of the vehicle, such as an autonomous vehicle controller that provides a level of autonomous driving. The torque request is received by the control unit 102 and forwarded directly to the respective in wheel electric motors in the form of a torque demand command and/or a brake system controller.

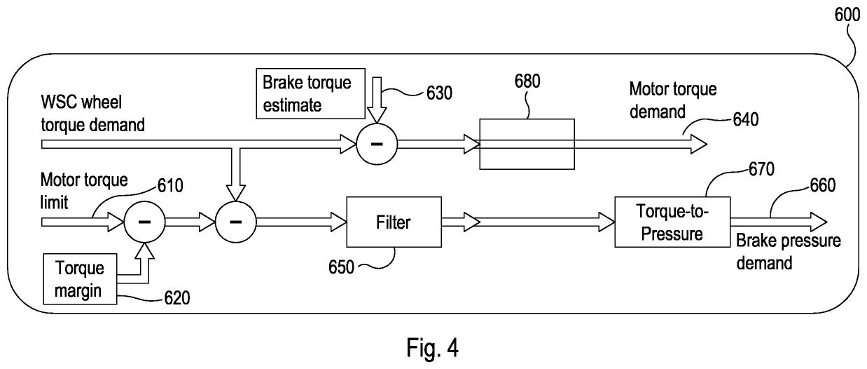

An embodiment of the controller 600 for the brake system according to the present invention will now be described with reference to FIG. 4.

A brake torque demand is communicated from the control unit 102 to the brake system controller 600 illustrated in FIG. 4, where the brake system controller 600 includes an input 610 for a motor torque limit, a torque margin value 620, an input 630 for a brake torque estimate, an output motor torque demand 640, a filter 650, a torque to pressure converter 670, a motor torque limitation function 670 and an output 660 for brake pressure demand.

The brake torque demand received by the controller 600 indicates the total brake torque required to be applied to a wheel having an in-wheel electric motor and a friction brake.

The value assigned to the motor torque limit indicates a maximum regenerative braking torque that can be applied by the in-wheel electric motor. As discussed below, the effective motor torque limit may be modified using the torque margin value 620, where the torque margin value 620 is subtracted from the motor torque limit, thereby providing a mechanism for restricting the amount of regenerative braking that may be applied by the in-wheel electric motor. Based on the motor torque limit value the brake torque demand value is separated into a friction brake torque component and a regenerative brake torque component. For example, if the total brake torque demand is 1000 Nm and the motor torque limit value (i.e. the maximum regenerative braking torque that can be applied to the in-wheel electric motor) is 300 Nm, the controller issues a friction brake torque demand of 700 Nm, with the remaining brake torque being applied by the in-wheel electric motor via regenerative braking.

The friction brake torque demand is converted into a brake pressure demand via the use of the filter 650 and the torque to pressure converter, where the torque to pressure converter provides a pressure demand for the friction brakes based on brake system characteristics.

To compensate for variations between the friction brake torque demand generated by the controller 600 and the actual friction brake torque applied by the friction brake, an estimate of the applied friction brake torque is determined by any suitable means, for example an estimate of the actual brake pressure in conjunction with a pressure to torque model, and compared with the friction brake torque demand. The controller 600 is arranged to compensate for any difference between the estimated brake torque and the friction brake torque demand by adjusting the regenerative brake torque demand communicated to the in-wheel electric motor, where the quick torque response of the in-wheel electric motor allows this to be achieved without any noticeable degradation in braking performance.

To maximise the efficiency of the brake system and ensure that maximum regenerative current is obtained from the in-wheel electric motor during braking, it is desirable that as much braking is performed by the in-wheel electric motor as possible. However, if an in-wheel electric motor is used to generate its maximum regenerative current, if the estimated friction brake torque is less than the required friction brake torque demand generated by the controller 600, this difference in brake torque cannot be compensated using the in-wheel electric motor, but must be compensated by varying the friction brake torque demand, which is slower to apply than would be achieved using an in-wheel electric motor.

To address this issue, the torque demand value is varied depending on different modes of operation for the brake controller.

In a preferred embodiment, the controller 600 is configured to operate in two modes of operation. In a first mode of operation, corresponding to a normal braking mode, the controller 600 is arranged to place an emphasis on maximising regenerative efficiency. In a second mode of operation, corresponding to an anti-lock braking system mode, the controller 600 is arranged to place an emphasis on braking efficiency.

In the first mode of operation, an emphasis is placed on maximising regenerative braking efficiency by setting a low torque margin value, where as discussed above, the torque margin value is used to modify the value assigned to the motor torque limit. For example, by setting the torque margin value to zero, the value assigned to the motor torque limit is used for determining the friction brake torque demand value without modification from the torque margin value. By way of illustration, if the brake torque demand value is 1000 Nm, and the motor torque limit is 300 Nm, the controller 600 generates a motor brake torque demand of 300 Nm and a friction torque demand of 700 Nm. As stated above, any variation between the brake torque estimate and the friction brake torque demand is accommodated by modulating the friction brake torque demand, where under a normal braking operation the slower brake response time for modulating the friction brake will not be noticed.

In the second mode of operation, an emphasis is placed on maximising braking efficiency, at the expense of regenerative braking efficiency, by setting a higher torque margin value than for the first mode, where the torque margin value is subtracted from the motor torque limit. Consequently, for a given brake torque demand, a higher torque margin value in the second mode of operation will result in a higher friction brake demand relative to the motor brake torque demand when compared with the lower torque margin value for the first mode of operation.

For example, by setting the torque margin value to 100 Nm, a reduced motor torque limit is used for determining the friction brake torque demand value. By way of illustration, if the brake torque demand value is 1000 Nm, the motor torque limit is 300 Nm and the torque margin is 100 Nm, the controller generates a motor brake torque demand of 200 Nm (i.e. 300-100) and a friction brake torque demand of 800 Nm. Consequently, as the electric motor still has capacity to provide additional regenerative braking, any variations between the brake torque estimate and the friction brake demand, up to a value of 100, may be resolved by modulating the motor brake torque, thereby taking advantage of the quick torque response provided by the electric motor to apply any braking correction quickly. To ensure that the motor torque limit isn't exceeded the motor torque limitation function 670 monitors the motor brake torque demand to ensure that the motor brake torque demand is equal or less than the motor torque limit.

The controller 600 may switch between the first mode of operation and the second mode of operation using any suitable means, for example via a control signal from the control unit 102 indicating an ABS braking response is required or via detection of the wheel of the vehicle driven by the in-wheel electric motor having a wheel velocity below a minimum wheel velocity.

For an improved driving experience the filter may be used for filtering the indicated friction braking torque value, wherein the filtering characteristics of the filter vary between the first mode of operation and the second mode of operation.

For example, in a preferred embodiment, the filter is arranged to provide a smoother application of friction braking torque in the first mode of operation relative to the second mode of operation.

Preferably, the controller is arranged to modulate the regenerative braking torque applied by the first electric motor to the first wheel to maintain the speed of the first wheel above a minimum wheel velocity, wherein the minimum wheel velocity is determined based on a first slip ratio value for the first wheel and the vehicle velocity.

Additionally, in a preferred embodiment, the control unit 102 provides traction control functionality, where the control unit 102 is arranged to determine the speed of the vehicle. For example, the velocity of an un-driven wheel of the vehicle may be measure or GPS measurements may be used to determine the speed of the vehicle; however, any suitable means may be used.

To achieve optimum torque transfer between the road and the vehicle under both acceleration and braking the control unit 102 is configured to use the vehicle speed information to determine a maximum desired slip ratio limits for an accelerating condition for each wheel and a minimum desired slip ratio limits for a braking condition for each wheel.

For example, the control unit 102 can be arranged to map car speed to a maximum/minimum slip ratio, where the mapping function can be performed in any number of ways, such as via a table or use of an algorithm.

Knowing the speed of the vehicle and having a maximum and minimum desired slip ratio limit value, the control unit 102 is arranged to calculate a maximum and minimum speed limit for each wheel driven by an in-wheel electric motor. In other words, for the given speed of the vehicle the maximum speed limit (i.e. for an accelerating condition) of the wheel will result in a sliding between the tire fitted to the wheel and road that would correspond to the maximum desired slip ratio, and the minimum speed limit (i.e. a braking condition) of the wheel will result in a sliding between the tire fitted to the wheel and road that would correspond to the minimum desired slip ratio. However, any suitable means for determining a maximum and minimum speed limit using the maximum and minimum desired slip limit values may be used.

The control unit 102 is arranged to communicate the torque demand request and the maximum and minimum speed limit values associated with each driven wheel to the respective in wheel electric motors and/or the controller, as discussed above, where in a preferred embodiment the controller 600 is incorporated into the control device 400 that form part of the in-wheel electric motor.

Upon the respective in-wheel electric motors receiving the torque demand request, the in-wheel electric motors are arranged to control current flow within the coil winding to generate the requested torque demand, as discussed above, while monitoring the rotational speed of the rotor.

As a result of the higher mass of the vehicle compared to that of a wheel of the vehicle, typically the change in velocity of the vehicle will be relatively slow compared to that of the wheel in the situation where torque is being directly applied to the wheel, which causes the wheel to enter a slip condition.

Consequently, the update rate of the maximum and minimum speed limits for the vehicle, which are generated by the control unit 102, can be performed relatively slowly compared to the update rate required for torque control applied by the control device of the in wheel electric motors.

1. A brake system for a vehicle having a first electric motor arranged to provide regenerative braking torque to a first wheel and a friction braking device arranged to provide a friction brake torque to the first wheel, the brake system comprising:
a controller arranged in response to receiving a torque demand to generate a first control signal for applying a regenerative braking torque by the first electric motor to the first wheel, wherein the first control signal provides an indication of a regenerative braking torque value, and a second control signal for applying a friction braking torque by the friction braking device to the first wheel, wherein the second control signal provides an indication of a friction braking torque value, wherein upon determining an estimate for the friction braking torque applied to the first wheel the controller is arranged to modulate the regenerative braking torque applied by the first electric motor to the first wheel based on the difference between the friction braking torque value indicated by the second control signal and the estimated friction braking torque.

2. A brake system according to claim 2, wherein the controller is arranged to modulate the regenerative braking torque applied by the first electric motor to compensate for a difference between the friction braking torque value indicated by the second control signal and the estimated friction braking torque.

3. The brake system according to claim 1, wherein the controller is arranged to operate in a first mode of operation or a second mode of operation based on a received control signal.

4. The brake system according to claim 3, wherein the first mode of operation is a normal braking mode of operation and the second mode of operation is an anti-lock braking system, ABS, mode of operation.

5. The brake system according to claim 3, wherein the controller is arranged to vary the indicated regenerative braking torque and the indicated friction braking torque based on whether the controller is operating in the first mode of operation or the second mode of operation.

6. The brake system according to claim 3, wherein the controller is arranged to vary the ratio of the indicated regenerative braking torque and the indicated friction braking torque by varying a torque margin value to a regenerative torque limit for the first electric motor when switching between the first mode of operation and the second mode of operation.

7. The brake system according to claim 6, wherein for the same received torque demand, a low torque margin value is arranged to provide increased regenerative current and a lower indicated friction braking torque relative to a high torque margin value.

8. The brake system according to claim 3, wherein the controller includes a filter for filtering the indicated friction braking torque value.

9. The brake system according to claim 8, wherein the filtering characteristics of the filter vary between the first mode of operation and the second mode of operation.

10. The brake system according to claim 9, wherein the filter is arranged to provide a smoother application of friction braking torque in the first mode of operation relative to the second mode of operation.

11. A brake system according to claim 1, wherein the controller is arranged to modulate the regenerative braking torque applied by the first electric motor to the first wheel to maintain the speed of the first wheel above a minimum wheel velocity.

12. A brake system according to claim 11, wherein the minimum wheel velocity is determined based on a first slip ratio value for the first wheel and the vehicle velocity.
